(19) United States
(12) Patent Application Publication
(10) Pub. No.: US 2007/0036297 A1
(43) Pub. Date: Feb. 15, 2007

(54) Method and system for warping voice calls

(76) Inventors: Carlos A. Miranda-Knapp, Miramar, FL (US); James P. Ashley, Naperville, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/192,165

(22) Filed: Jul. 28, 2005

(51) Int. Cl. H04M 1/64; H04M 15/06

(52) U.S. Cl. 379/88.19; 379/142.01

(57) ABSTRACT

A communication device (10) can include a transceiver (12), a transducer or microphone (14) coupled to the transceiver for receiving voice input from a user, and a processor (16) coupled to the transceiver. The processor can be programmed to receive (32) a predetermined type of phone call or an indication of a caller indication from a calling party and warp (38) a voice input from the user of the communication device based on the caller indication. How the predetermined type of phone call is determined can be done in a number of ways including using an optional caller identification module (18). The caller ID module can provide information on whether the caller is recognized or whether the caller ID information is unavailable.

### FIELD OF THE INVENTION

This invention relates generally to warping or altering voice calls or characteristics, and more particularly to a method and system for warping a voice call based on knowledge about a caller.

### BACKGROUND OF THE INVENTION

With the advent of contact lists on cell phones and the proliferation of Caller identification (ID) services, a good number of phone users use a Caller ID field to screen incoming calls, and often fail to answer incoming calls unless the name/number displayed in the Caller ID field is recognized. This means that some potentially important calls could be missed. For instance, a user may have filled out a form/questionnaire at a local business establishment (for example, an information request card at a Real Estate office) but may not have entered the office's phone number into the contact list. A call from such office could inadvertently be ignored because the number displayed in the Caller ID field is not recognized. One reason why a person screens incoming calls may be to ignore calls from telemarketers. Another reason may be for fear of falling victim to repeated crank calls, which typically originate from (Caller ID) blocked lines.

### SUMMARY OF THE INVENTION

Embodiments in accordance with the present invention can provide a mechanism that enables a call recipient to answer a call, but still provide some kind of “insulation” to safeguard aspects of the recipient's identity from the person originating the call. A person's voice conveys information about their sex and age, and sometimes even their ethnic group. A voice altering method such as a voice pitch shifting/warping algorithm could be used to disguise the call recipient's voice by lowering or raising the pitch as desired, making it sound much deeper or higher than it is. Such an effect can disguise a person's sex and/or age and could potentially deter a crank caller from calling again. Note, the voice warping techniques described herein can also be intentionally used as a novelty or gimmick among friends, family members and co-workers or as a means of purposely avoiding knowledge of a caller's identity by eavesdroppers or a casual passerby at the called party's end. Further note, altering or modifying a voice call or voice or speech characteristics shall be referred to herein generically as “warping.”

In a first embodiment of the present invention, a method for warping a voice call can include the steps of receiving a predetermined type of phone call or caller indication from a calling party and warping voice input from a called party based on the predetermined type of phone call or caller indication. The predetermined type of phone call or caller indication can have a predetermined caller ID such as a specific person's number or an “unavailable” or “unknown” or “blocked” identification. Besides Caller ID, the caller indication can also be information such as location (e.g, if the caller has location services and can transfer such information to the called party), height, weight, eye color, fingerprint data, or almost any other information indicative of the caller. Of course, a caller indication would not include a ring voltage since this information normally fails to differentiate one caller from another. Note, the warping can be done for example by altering the pitch of the voice input from the called party by forming Doppler shifted versions of the voice input and crossfading the Doppler shifted versions. Crossfading can be done by summing the Doppler shifted versions of the voice input together by alternating relative gains of each component of Doppler shifted versions.

In a second embodiment of the present invention, a communication device can include a transceiver, a microphone coupled to the transceiver for receiving voice input from a user, and a processor coupled to the transceiver. The processor can be programmed to receive a predetermined type of phone call or caller indication from a calling party and warp voice input from the user based on the predetermined type of phone call or caller indication. The voice input can be warped for example by altering the pitch of the voice input from the user by forming Doppler shifted versions of the voice input and crossfading the Doppler shifted versions. Note, the communication device can be among a cellular phone, a smart phone, a satellite phone, and a two-way radio as examples.

In a third embodiment of the present invention, a portable cellular phone can include a transceiver, a microphone coupled to the transceiver for receiving voice input from a user, a caller identification module for extracting caller identification information received from a calling party, and a voice input altering module that alters the voice input from the user based on the caller identification information extracted by the caller identification module. The voice input altering module can alter the voice input from the user if the caller identification information corresponds to a predetermined phone number or unavailable or unknown or blocked. The voice input altering module can alter the voice input by for example altering the pitch of the voice input from the user. The voice input can be altered for example by forming Doppler shifted versions of the voice input and crossfading the Doppler shifted versions. Crossfading can be done by summing the Doppler shifted versions of the voice input together by alternating relative gains of each component of Doppler shifted versions.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a block diagram of a communication device that can receive a predetermined type of phone call and warp voice input from a user based on the predetermined type of phone call in accordance with an embodiment of the present invention.

FIG. 2 is a block diagram of another communication device having a voice input altering module in accordance with an embodiment of the present invention.

FIG. 3 is a flow chart illustrating a method of method for warping a voice call based on receipt of a predetermined type of voice call in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

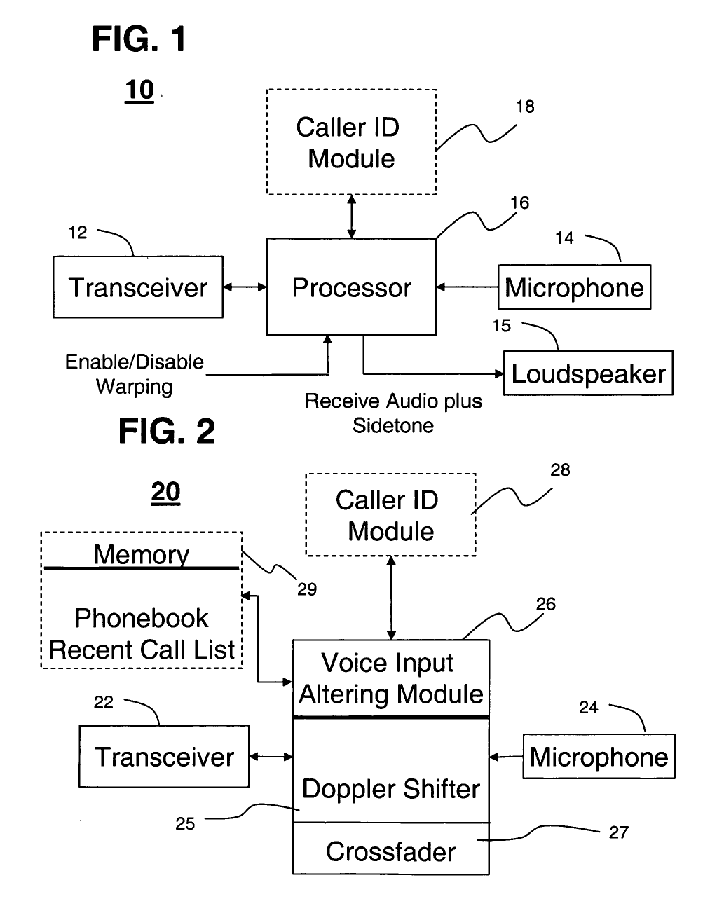

Referring to FIG. 1, a communication device 10 in accordance with an embodiment of the present invention can include a transceiver 12, a transducer or microphone 14 coupled to the transceiver 12 for receiving voice input from a user, and a processor 16 coupled to the transceiver 12. The processor 16 can be programmed to receive a predetermined type of phone call or caller indication from a calling party and warp a voice input from the user of the communication device based on the predetermined type of phone call. How the predetermined type of phone call is determined can be done in a number of ways including using an optional caller identification (ID) module 18. The caller ID module 18 can provide information on whether the caller is recognized or whether the caller ID information is unavailable. Also shown in FIG. 1 is a warping verification circuit in the form of a speaker 15 (and processor 16) where the modified speech can be monitored by the user. This capability insures that the user knows when and how the voice modification is being performed, and can prevent inadvertent assertion of this voice warping feature. The monitor circuit presents the modified speech signal to the user in the form of “sidetone”, which is well known in the art. Additionally, an activate/deactivate control mechanism is provided to easily control the enabling and disabling of this feature.

The manner in which the predetermined type of phone call is determined is not necessarily limited to just using a caller ID module, but other arrangements or methods that would enable a comparison between caller ID information and stored data such as data in a phonebook or a recent call list or a hot list can also be used. The manner in which the voice input is warped is not necessarily limited either. For example, the voice input can be warped by altering the pitch of the voice input from the user by forming Doppler shifted versions of the voice input and crossfading the Doppler shifted versions. The pitch could be shifted up or down or other voice parameters can be altered in accordance with any number of embodiments herein. Note, the communication device can be among a cellular phone, a smart phone, a satellite phone, or a two-way radio. The communication device could also be a wired phone line as well.

In a more specific embodiment as shown in FIG. 2, a portable cellular phone 20 can include a transceiver 22, a transducer or microphone 24 coupled to the transceiver 22 for receiving voice input from a user, a caller identification module 28 for extracting caller identification information received from a calling party, and a voice input altering module 26 that alters the voice input from the user based on the caller identification information extracted by the caller identification module 28. The voice input altering module 26 can alter the voice input from the user if the caller identification information is unavailable or unknown or blocked. The voice input altering module 26 can alter the voice input by for example altering the pitch of the voice input from the user. The voice input can be altered for example by forming Doppler shifted versions of the voice input using Doppler shifter 25 and crossfading the Doppler shifted versions using crossfader 27. Crossfading can be done by summing the Doppler shifted versions of the voice input together by alternating relative gains of each component of Doppler shifted versions. The portable cellular phone 20 can further include a memory 29 that can contain a phonebook or recent call list or other stored data that can be used to compare with caller ID information received at the portable cellular phone 20.

The embodiment in FIG. 2 can use a pitch-shifting/voice warping software application for cell phones that can enable the user to either decrease or increase the pitch of his or her voice. One method among many techniques for warping voice that can be used can be based on a Doppler shift & crossfade technique. This technique uses two staggered delayed (Doppler Shift) versions of the audio signal and sums them together by alternating relative gains of each component (crossfading). This warping technique can disguise a user's voice and thus provides some sense of protection (shielding) from unknown callers and crank-callers. It can also be used as a gimmick or novelty item among friends, relatives or co-workers.

Although voice warping is not necessarily limited to altering pitch, most likely warping techniques will use some form of pitch shifting. One simple algorithm can involve altering the pitch only when the Caller ID indication is “unavailable”. For example, a high level software algorithm can appear as follows:
if (CallerID==“unavailable”) then
Pitch=x*Pitch;
endif
   where x is some scaling value.

Note, there are many techniques in the art for warping an input voice or speech signal. Thus, it should be understood that pitch shifting or other voice modification techniques used responsively to any predetermined caller ID information or caller indication is contemplated within the scope of the claims. For example, it may desirable to modify one's voice when a particular friend calls or a relative, or a co-worker. Further note, since some existing voice compression systems (already found in cellular phones) typically utilize a “pitch lag” parameter, such pitch lag parameter can be further modified to produce a pitch shift in reconstructed speech with virtually no additional complexity impact. Other voice modification techniques can involve “spectral inversion”, “ring modulation”, or any one of a combination of these and/or other various techniques.

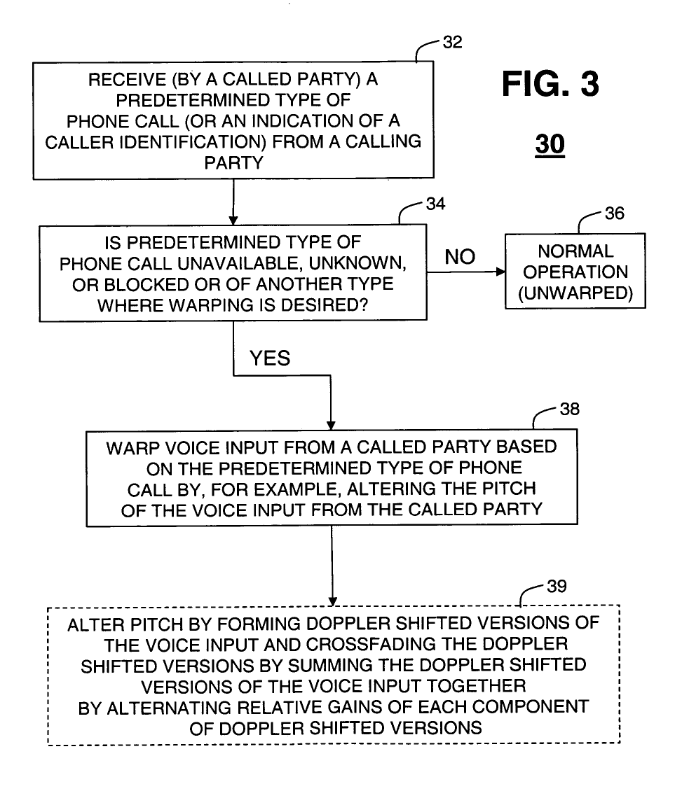

Referring to FIG. 3, a flow chart illustrating a method 30 for warping a voice call is shown. The method 30 can include the step 32 of receiving a predetermined type of phone call or caller indication from a calling party. At a decision step 34, a determination is made as to the “type” of predetermined type of phone call. If the predetermined type of phone call is not “unavailable”, “unknown”, “blocked” or if the predetermined phone call is not of another type where warping is otherwise desired, then the communication device will operate normally at step 36 without warping voice inputs. On the other hand, if the predetermined type of phone call is “unavailable”, “unknown”, “blocked” or if the predetermined phone type is of another type where warping is otherwise desired, then the method 30 can proceed to step 38 by warping voice input from a called party based on the predetermined type of phone call. The predetermined type of phone call can have a predetermined caller ID such as a specific person or an “unavailable” or “unknown” or “blocked” identification. Note, the warping can be done for example by altering the pitch of the voice input from the called party by forming Doppler shifted versions of the voice input and crossfading the Doppler shifted versions as noted in step 39. Crossfading can be done by summing the Doppler shifted versions of the voice input together by alternating relative gains of each component of Doppler shifted versions.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for warping a voice call, comprising the steps of:
receiving by a called party an indication of a caller indication; and
warping voice input from the called party based on the indication of the caller indication.

2. The method of claim 1, wherein the step of receiving comprises receiving a call having a caller identification.

3. The method of claim 2, wherein the indication of the caller identification is unavailable.

4. The method of claim 1, wherein the method further comprises the step of monitoring the voice input from the called party that has been warped.

5. The method of claim 1 wherein the step of warping comprises forming Doppler shifted versions of the voice input and crossfading the Doppler shifted versions.

6. The method of claim 5, wherein the step of crossfading comprises the step of summing the Doppler shifted versions of the voice input together by alternating relative gains of each component of Doppler shifted versions.

7. The method of claim 1, wherein the step of warping comprises one or more among altering the pitch of the voice input from the called party, altering the voice input using spectral inversion, and altering the voice input using ring modulation.

8. A communication device, comprising:
a microphone for receiving voice input from a user; and
a processor coupled to the microphone, wherein the processor is programmed to:
receive an indication of a caller indication; and
warp the voice input from the user based on the indication of a caller indication.

9. The communication device of claim 8, wherein the processor is programmed to warp voice input based on receiving a call having a caller identification.

10. The communication device of claim 9, wherein the indication of the caller identification is unavailable.

11. The communication device of claim 8, wherein the processor is programmed to warp the voice input by altering the pitch of the voice input from the user.

12. The communication device of claim 11, wherein processor is programmed to warp the voice input by forming Doppler shifted versions of the voice input and crossfading the Doppler shifted versions.

13. The communication device of claim 12, wherein the processor is programmed to crossfade by summing the Doppler shifted versions of the voice input together by alternating relative gains of each component of Doppler shifted versions.

14. The communication device of claim 8, wherein the portable communication device is selected among portable communication devices comprising a cellular phone, a smart phone, a satellite phone, and a two-way radio.

15. The communication device of claim 8, wherein the processor is programmed to warp the voice input by performing one or more among altering the pitch of the voice input from the called party, altering the voice input using spectral inversion, and altering the voice input using ring modulation.

16. A portable cellular phone, comprising:
a transceiver;
a microphone coupled to the transceiver for receiving voice input from a user;
a caller identification module for extracting caller identification information received from a calling party; and
a voice input altering module that alters the voice input from the user based on the caller identification information extracted by the caller identification module.

17. The portable cellular phone of claim 16, wherein the voice input altering module alters the voice input from the user if the caller identification information corresponds to a predetermined phone number or an unavailable phone number or an unknown phone number or a blocked phone number.

18. The portable cellular phone of claim 16, wherein the voice input altering module alters the voice input by altering the pitch of the voice input from the user.

19. A machine-readable storage, having stored thereon a computer program having a plurality of code sections executable by a machine for causing the machine to perform the steps of:
receiving by a called party an indication of a caller indication; and
warping voice input from the called party based on the indication of the caller indication.

20. The machine readable storage of claim 19, wherein the computer program further comprises a plurality of code sections for causing the machine to monitor the voice input from the called party that has been warped
